(19) United States
(12) Patent Application Publication
(10) Pub. No.: US 2017/0147177 A1
(43) Pub. Date: May 25, 2017

(54) METHOD OF TRANSMITTING INFORMATION VIA A VIDEO CHANNEL BETWEEN TWO TERMINALS

(71) Applicant: STUDEC, BLAGNAC (FR)

(72) Inventors: PHILIPPE CHABALIER, VIGOULET AUZIL (FR); NOËL KHOURI, GOYRANS (FR)

(21) Appl. No.: 15/300,352

(22) PCT Filed: Apr. 2, 2015
(86) PCT No.: PCT/FR2015/050869

§ 371 Date: Oct. 26, 2016

(30) Foreign Application Priority Data
Apr. 2, 2014 (FR) 1452923

(51) Int. Cl. G06F 3/0488; G06F 3/0484; H04N 7/15; H04L 29/06

(52) U.S. Cl. CPC G06F 3/0488; H04L 65/403; H04L 65/1069; G06F 3/04845; H04N 7/15

(57) ABSTRACT

A method of transmitting information between at least two users furnished with display screens. One of the users being furnished with an image acquisition device. The users are linked to a communication network. Images are acquired by a sender user and transmitted to the other users. Images are displayed on the screens of all the users, both the sender and observers. An area of interest in the image is identified by the sender user or an observer user, which determines a pointer on the display screen that is associated with that user. The coordinates the pointer on the image are transmitted to the other users, and the pointer of the area of interest is displayed on the screens of all the users.

### RELATED APPLICATIONS

This application is a §371 application from PCT/FR2015/050869 filed Apr. 2, 2015, which claims priority from French Patent Application No. 14 52923 filed Apr. 2, 2014, each of which is herein incorporated by reference in its entirety.

### FILED OF THE INVENTION

The invention relates to the field of information transmission methods. It relates more particularly to a method of transmitting information between two users via a video channel.

### OBJECT AND SUMMARY OF THE INVENTION

The invention relates primarily to a method of transmitting information between at least two users equipped with image display means, at least one of these users also being equipped with image acquisition means, the users being connected to a communication network allowing video sequences or still images to be exchanged in real time.

The method comprises at least the following steps:

100—Opening of a video communication session between the users,

200—Acquisition of images by a first user, referred to here as the transmitting user, and transmission of these images to the other users, referred to as the watching users, more or less in real time,

300—Display of the received images on the display means of all of the users, both the transmitting user and the watching users, connected to the session,

400—Identification by the transmitting user or a watching user of an area of interest of the image, corresponding, for example, to an object shown by said image, this identification determining an area pointer on the display screen, this pointer been associated with the creating user,

500—Transmission of the coordinates on the image of this pointer to an area identified by one user to the other users, and display of the pointer to the area of interest on the display screen of all of the users.

The pointer possibly comprises an identification of the user transmitting this area of interest pointer.

The display means may comprise, in particular, a flat display screen, augmented reality vision goggles or any other image display system.

The image acquisition means comprise, for example, a video camera, a webcam or a 3D scanner.

In other words, in a particular example embodiment, it is understood that the two users, each equipped with a system including, for example, a tablet PC (combining a touchscreen, one or two webcams, computing and communication means), may exchange information with one another to designate an object filmed by the webcam of one of the two terminals.

The display screens of the users display by default the same image during at least a part of the session.

It is understood that the users thus see the same video and simultaneously see their area designation pointers and the area designation pointer of the other users.

In one particular embodiment, the image display means of at least one user are a touch display screen, i.e. equipped with means for designating points on these images, and the identification by the user of an area of interest is implemented directly by touch on his display screen.

In one particular embodiment, the pointer for designating the area of interest is a circle and the identification of the transmitting user is implemented in the form of a texture code or color code of the area, each user being associated with a particular texture and/or a particular color.

In one embodiment which is conducive to a good interaction between the users, pointers associated with each user are continuously displayed on the display screen of each user connected to the same session.

Advantageously, in this case, the designation pointers are initially positioned, at the start of the session, outside the filmed image area itself, for example in a lateral area of the image, only the designation pointers currently being used by the one or the other user being positioned on these areas of the image itself.

In one advantageous embodiment, each designation pointer can be moved only by the user who is associated with it.

In one particular embodiment, the movement by a user of his designation pointer is implemented by touching and dragging the designation pointer on the screen from its initial position to the intended position on the image.

In one particular embodiment, the method furthermore comprises a step of moving the designation pointer correlatively to the movement of the object that it designates on the display screen, during the movements of the camera facing said object.

### BRIEF DESCRIPTION OF THE DRAWINGS

The characteristics and advantages of the invention will be better understood from the description that follows, said description explaining the characteristics of the invention by means of a non-limiting application example.

The description is based on the attached figures, in which:

FIG. 1 shows the different elements involved in an embodiment of the invention and the main steps of the method,

FIG. 2 shows the same elements in a variant embodiment of the invention,

FIG. 3 shows the same elements in a second variant embodiment of the invention,

FIG. 4 shows a detail of the elements implemented in a third variant embodiment of the invention.

### DETAILED DESCRIPTION OF AN EMBODIMENT OF THE INVENTION

In the present embodiment, given here as illustrative and non-limiting, a device according to the invention is used in a video and possibly audio exchange session between two users or between one transmitting user and a plurality of watching users.

In the present non-limiting example, the method is implemented using software.

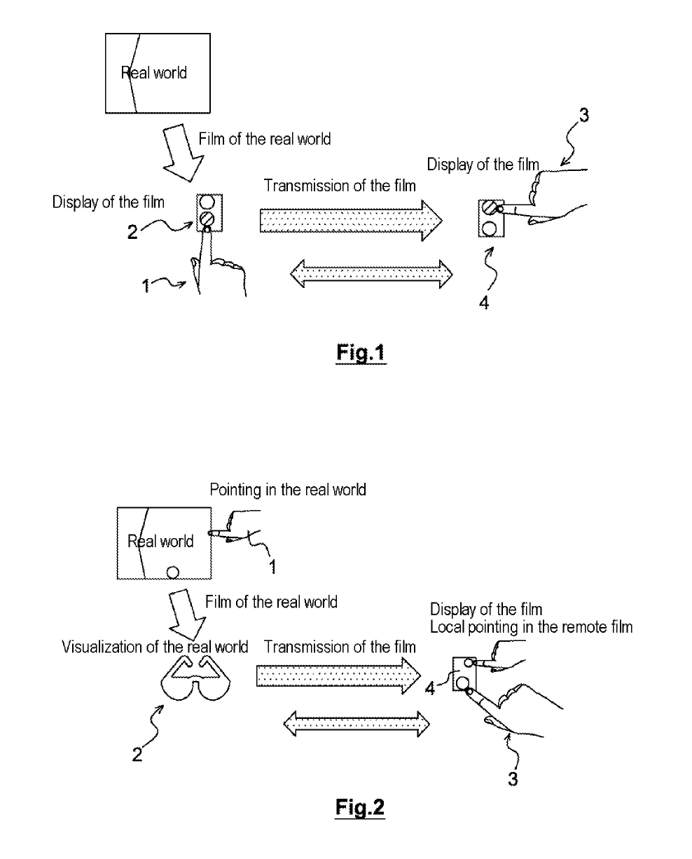

As shown in FIG. 1, the method implements, in an example embodiment given here as illustrative and in no way limiting, at least one first user 1, equipped with a first terminal 2, and at least one fixed user 3, equipped with a second terminal 4.

In the example embodiment given here, the first data terminal 2 and the second data terminal 4 are similar and of the tablet PC type. They may also be mobile telephones of the Smartphone type, computers of the PC type, etc. it is assumed here that the first terminal 2 and the second terminal 4 both comprise display means and means for designating a point on the screen. These means for designating a point on the screen are typically in the form of a device for sensing the position of a finger on the screen, in the case of tablet PCs equipped with touchscreens. In variant embodiments, this may involve mice, trackpads or other means known to the person skilled in the art.

The first terminal 2 and the second terminal 4 are connected to a communication network, for example a wireless network, in particular GSM or Wi-Fi. The first terminal 2 and the second terminal 4 each comprise means for running a software application implementing a part or all of the method.

At least one of the first terminal 2 and the second terminal 4 comprises image acquisition means. In one advantageous embodiment, these image acquisition means allow the acquisition of video sequences. They are, for example but non-limitingly, video cameras of the webcam type. In the present example, the two terminals 2, 4 comprise image acquisition means of the webcam type.

In the preferred embodiment, at least one of the first terminal 2 and the second terminal 4 comprises a webcam which can be or is oriented in a fixed manner more or less in the direction opposite to the line of vision of the user, i.e., in other words, towards the half-space located behind the mobile terminal.

In the case of a plurality of cameras for the same peripheral, the communication between users may apply to any one of the cameras, for example a camera in front or behind a tablet.

Alternatively, the communication is established between users equipped with vision goggles or headsets connected via included cameras.

The method comprises a plurality of successive steps. The diagram in FIG. 1 explains graphically this concept for screen peripherals.

100—Opening of a video communication session between the users. The users are put in contact with one another by means of a directory known per se.

This video communication may be from terminal to terminal, directly or via a server.

This session opening comprises the designation of a transmitting user 1.

200—Acquisition of images by the transmitting user 1 and transmission of these images to the watching users 2 in real time.

Once connected, the transmitting user 1 sends a video image from the camera of his choice to one or N connected watching users 3. The transmitting user 1 therefore sends an image of what he is filming, this image also being displayed on the display screen of his terminal 2 in the case of a screen terminal, or being direct vision in the case of peripherals of the augmented reality vision goggles type.

300—Display of the received images on the display means 4 of the watching user 3. All of the users (both the transmitting user 1 and the watching users 3) then see the same image on the display screen: the image acquired by a video camera of the transmitting user 1.

400—Identification by the first user 1 or the second user 3 of an area of interest of the image, corresponding, for example, to an object shown by said image, this identification determining a pointer on the display screen.

The transmitting user 1 and the watching user(s) 3 can each have pointers on their display screen 2, 4 in the form of graphical markers (circle, dot, arrows, images, drawings of an area, etc.).

500—Transmission of this pointer to an area identified by one user to the other users and display of the pointer to the area of interest on the display screen of the other users and display of an identification of the transmitting user of this area of interest pointer.

The pointers are therefore transmitted to the film common to all of the users of the same session and are seen by all of the users, regardless of whether they are the transmitting user 1 or one of the watching users 3. In the case of touchscreens, these pointers follow the movements of the finger of the user who positions them. They are displayed on all of the terminals at the same coordinates relatively to the displayed image.

In other words, all of the users, both the transmitting user 1 and the watching users 3 see, on the display screen of their terminal, the combination of the film transmitted by the video camera of the transmitting user 1 and all of the pointers (graphical markers) placed by all of the users, both the transmitting user 1 and the watching users 3.

In one variant embodiment, the method can be reversed: the transmitting terminal 2 becoming the receiver and the receiving terminal 4 becoming the transmitter. Each user, when he is the transmitting user, decides on the camera to be used on his terminal: front or rear camera, depending on whether he wants his face or the environment located beyond his terminal to be seen.

The diagram shown in FIG. 2 explains graphically this concept for peripherals of the goggles and screen type. In the case illustrated by this figure, the transmitting user 1 has display and image acquisition goggles and points directly with his finger in the real world to the object that he wishes to designate. The watching users 3 see this designation on their display screen. In the reverse direction, the watching users can create pointers by touching the display screen and the transmitting user 1 sees these pointers displayed in superimposition on the objects of the real world via his augmented vision goggles.

In a second variant, possibly used in conjunction with the preceding variant, the pointing carried out in the real world is graphically represented on the transmitting device.

Each user decides on the camera to be used on his peripheral.

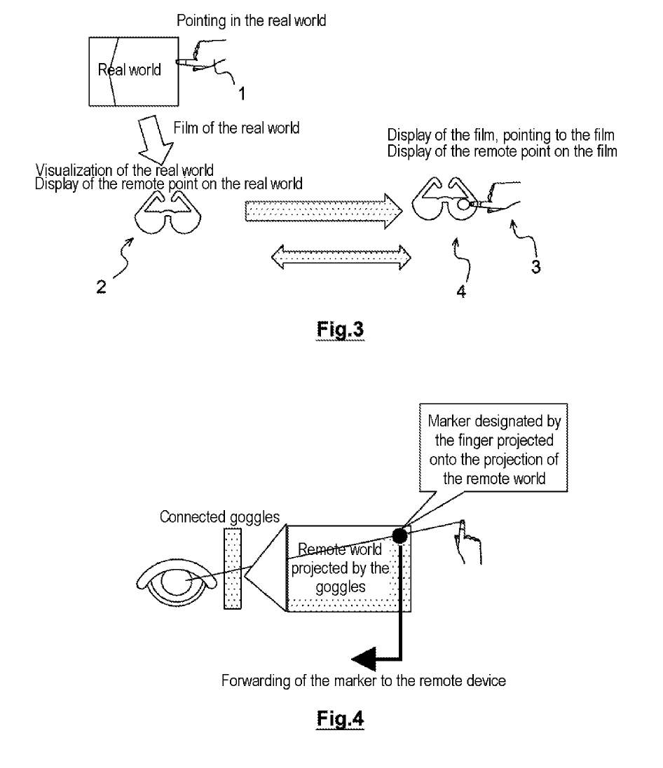

The diagram shown in FIG. 3 explains graphically this concept for peripherals of the goggles type on both sides.

In a different variant, on demand and for all types of terminals, a plurality of markers can be placed.

The pointing carried out in the real world is graphically represented on the image transmitted by the transmitting terminal 2.

The pointing to the received film is carried out by pointing with the finger in the real local space transcribed on the projection of the remote real world. This pointing is forwarded to the transmitting device as shown in FIG. 4.

### Advantages

The method as explained above allows, for example, the implementation of remote support, particularly in the case of product maintenance.

### Variant Embodiments Diverse variants can be envisaged, in conjunction with the method described above, these variants possibly being used according to technically possible combinations.

In a multi-receiver and multi-transmitter concept, the method is usable for a plurality of users according to the following methods:
Only one transmitter of the reference film at a given time
The transmitter can be selected from the community connected to the film
the remote pointings are differentiated (shape or accompanied by the name of the user) and displayed on the reference film (the film viewed by all).

In the case of a transmitting tablet, the transmission of the film captured by the video camera can be replaced by the transmission of the image of the screen. Everything that is visualized on the original screen is sent to the connected screens or goggles. Instead of sharing a film transmitted by one of the participants, the content of the screen is sent.

In a different concept, by using graphical interaction, a user designates a point and one of the users requests its continuation. In this case:
The pointer (circle, dot, arrow, etc.) is shown even if the pointing finger is no longer present.
It is positioned in the environment in 3D. In other words, the designated point remains at the same place in the 3 dimensions, regardless of the position of the device which films it.
This position is sent to the receiving devices on the film sent at the defined 3D position.

During the connection, data can be sent from the transmitting device to the receivers and vice versa. These data are:
Message
Text
Image
Video
etc.

The sent data can be consulted and visualized locally.

At the request of a (receiving or transmitting) user, the session can be recorded (film+graphical interactions and sound). These recordings can then be consulted by the community according to the rights defined for each user of the community.

The following elements can be recorded:
The film (image+sound)
The users connected during the session
The spatial coordinates of the device by means of the integrated sensors: GPS coordinates, direction of the compass, data communicated by the accelerometers.

The entire system (transmitting device+server) can learn to recognize an object in the real scene. The 3D description allowing the object recognition can be stored and reused by all of the devices connected to the system.

This recognition is based on the following methods:
The 3D description of the objects to be recognized is implemented by filming a real scene or on the basis of 3D models defined by a design office, for example.
This description can be stored locally in the device or on a server.
In automatic recognition mode, the film of the real scene is complemented by the insertion of graphical objects designating the recognized object(s).
The recognition of an object provides the following options:
   Overprinting of a marker on the object
   “Sensitivity” of the marker, the selection of the marker with the pointing device (finger, for example) allows the triggering of an action: visualization of a film interleaved with reality, display of a text, image or video element.
   The action can also be triggered automatically as soon as the object is recognized without prior selection.
   A previously recorded session as described by the concept 7 can be replayed.

1-9. (canceled)

10. A method of transmitting information between at least two users connected to a communication network allowing video sequences or still images to be exchanged in real time, each user is equipped with a display screen, at least one user is also equipped with an image acquisition device, the method comprising the steps of:
opening a video communication session between said at least two users;
acquiring images by a transmitting user;
transmitting the acquired images to the other users substantially in real time;
displaying the received images on the display screens of all of the users, both the transmitting user and watching users connected to the video communication session;
identifying an area of interest on an image by a creating user, the creating user is either the transmitting user or a watching user, the area of interest is associated with a designation pointer on the display screen of the creating user, the designation pointer is associated with the creating user;
transmitting coordinates of the designation pointer on said image identified by the creating user to other users connected to the video communication session; and
displaying the designation pointer on the display screens of all of the users connected to the video communication session.

11. The method according to claim 10, wherein the area of interest corresponds to an object shown in said image.

12. The method according to claim 10, wherein the designation pointer comprises an identification of the creating user.

13. The method according to claim 10, wherein the display screen of the creative user is a touch display screen enabling the creative user to designate and identify the area of interest by touching an area of the touch display screen. (New) The method according to claim 10, wherein the designation pointer is a circle; and
further comprising the step of identifying the creating user is implemented by a texture code or color code of the area of the interest, each user is associated with at least one of a predetermined texture and a predetermined color.

15. The method according to claim 10, wherein designation pointers associated with the users connected to the video communication session are continuously displayed on each display screen of the users connected to the video communication session.

16. The method according to claim 10, wherein at the start of the video communication session, designation pointers associated with the users connected to the video communication session are initially positioned outside a filmed image area; and
wherein only designation pointers currently being used by one or more users connected to the video communication session are positioned on corresponding areas of interest on said image.

17. The method according to claim 10, wherein each designation pointer is moveable only by the creating user associated with said each designation pointer.

18. The method according to claim 10, wherein a movement of the designation pointer by the creating user is implemented by touching and dragging the designation pointer on the display screen of the creating user from an initial position to a new position on said image.

19. The method according to claim 11, further comprising a step of moving the area pointer correlatively to a movement of the object on the display screen, during movements of the image acquisition device facing the object.
